(19) United States
(12) Patent Application Publication
(10) Pub. No.: US 2006/0243654 A1
(43) Pub. Date: Nov. 2, 2006

(54) Multi-functional water-filtering device

(76) Inventor: Tsung-Hui Lee, Tau-Yuan Hsien (TW)

Correspondence Address: LEE TSUNG-HUI, 235 Chung-Ho, Box 8-24, Taipei Hsien, 235, TW

(21) Appl. No.: 11/119,104

(22) Filed: May 2, 2005

(51) Int. Cl. B01D 35/28

(52) U.S. Cl. 210/445; 210/449; 210/424; 210/455; 210/94

(57) ABSTRACT

A multi-functional water-filtering device comprises a seat, a cylinder body combined at a lower side of the seat, and a filter body within the seat and the cylinder body; a lower end of the seat being connected with an outer ring; an inner ring and two small rings being formed within the large groove; one lateral side of the seat being formed with a lateral supporter. An upper tube and a lower ring are extended from the lateral supporter. The two small rings are located at two opposite sides of the inner ring. Each of the recess between any one of the small ring and the inner ring is installed with a rubber ring for waterproof. An end surface of the filter body is extended with a protruding ring which is embedded into the recess between the inner ring and the small ring.

### FIELD OF THE INVENTION

The present invention relates to water-filtering devices, and particularly to a multi-functional water-filtering device, wherein the multi-functional water-filtering device has a firm fastening structure so that the impurities are difficult to enter into the cleaner and moreover, the cylinder body is a transparent structure so that the user can view the inner side to know the state of the filter body and water.

### BCKGROUND OF THE INVENTION

In the prior art water-filtering device is installed aside a faucet, which occupies a space so that the user will feel inconvenient in operation. Furthermore, a water tube is necessary to install between the faucet and the water-filtering device. However impurities are easily accumulated in the water tube, even germs are grown in the tube. Thereby the water tube must be updated frequently so as to assure the purity of the water tube. A filter core is installed within the water-filtering device which is placed in a non-transparency casing. The user cannot know the state of the filter core. Thereby the user must update the core within a predetermined time period. Furthermore, the filter core only filters the impurities in the water, but the sizes of the water particles are remained, which is difficult to be absorbed by human bodies.

### SUMMARY OF THE INVENTION

Accordingly, the primary object of the present invention is to provide a multi-functional water-filtering device, wherein the multi-functional water-filtering device has a firm fastening structure so that the impurities are difficult to enter into the cleaner and moreover, the cylinder body is a transparent structure so that the user can view the inner side to know the state of the filter body and water.

To achieve above mentioned object, the present invention provides a multi-functional water-filtering device comprises a seat, a cylinder body combined at a lower side of the seat, and a filter body with the seat and the cylinder body; a lower end of the seat being connected with an outer ring; an inner ring and two small rings being formed within the large groove; one lateral side of the seat being formed with a lateral supporter. An upper tube and a lower ring are extended from the lateral supporter. The two small rings being located at two opposite sides of the inner ring. Each of the recess between any one of the small ring and the inner ring is installed with a rubber ring for waterproof. An end surface of the filter body is extended with a protruding ring which is embedded into the recess between the inner ring and the small ring.

The various objects and advantages of the present invention will be more readily understood from the following detailed description when read in conjunction with the appended drawing.

### BRIEF DESCRIPTION OF THE DRAWINGS

FIG. 1 is an exploded schematic view of the multi-functional water-filtering device of the present invention.

FIG. 2 is a schematic view of the multi-functional water-filtering device of the present invention.

FIG. 3 is a schematic cross view of the present invention.

FIG. 4 shows the switching of the handle of the present invention.

FIG. 5 is an exploded schematic view of another embodiment of the present invention.

FIG. 6 is an assembled schematic view about the multi-functional water-filtering device of the present invention.

FIG. 7 is a cross sectional view of another embodiment of the present invention.

FIG. 8 is an exploded schematic view about another embodiment of the present invention.

FIG. 9 is an assembled schematic view of another embodiment of the present invention.

FIG. 10 is a cross sectional view about another embodiment of the present invention.

FIG. 11 is a schematic view about the operation of the multi-functional water-filtering device of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

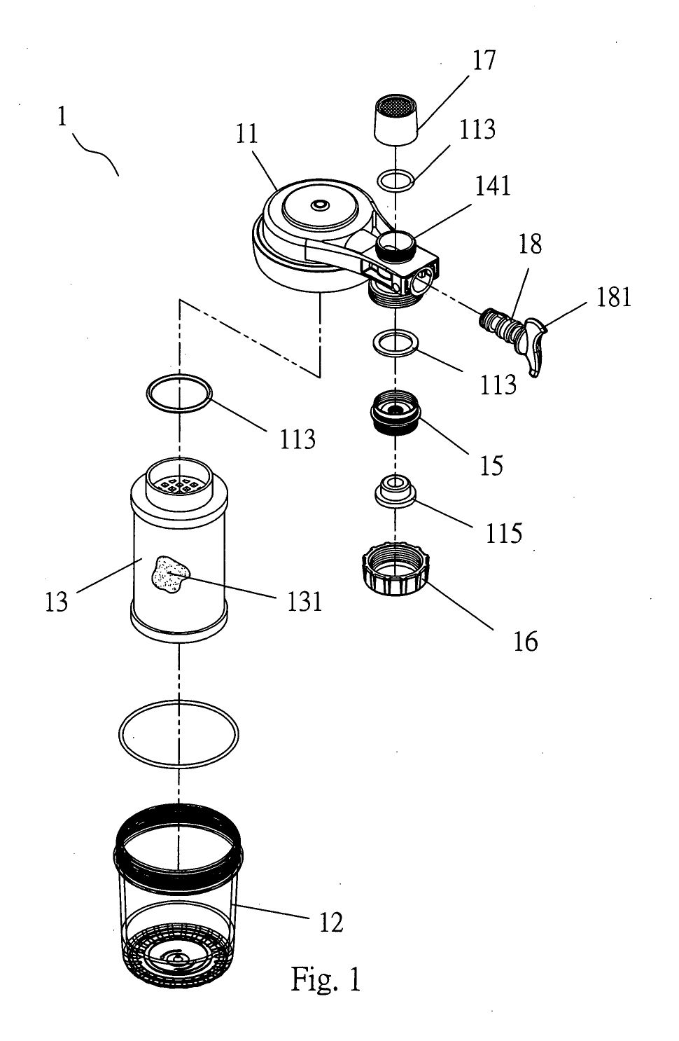

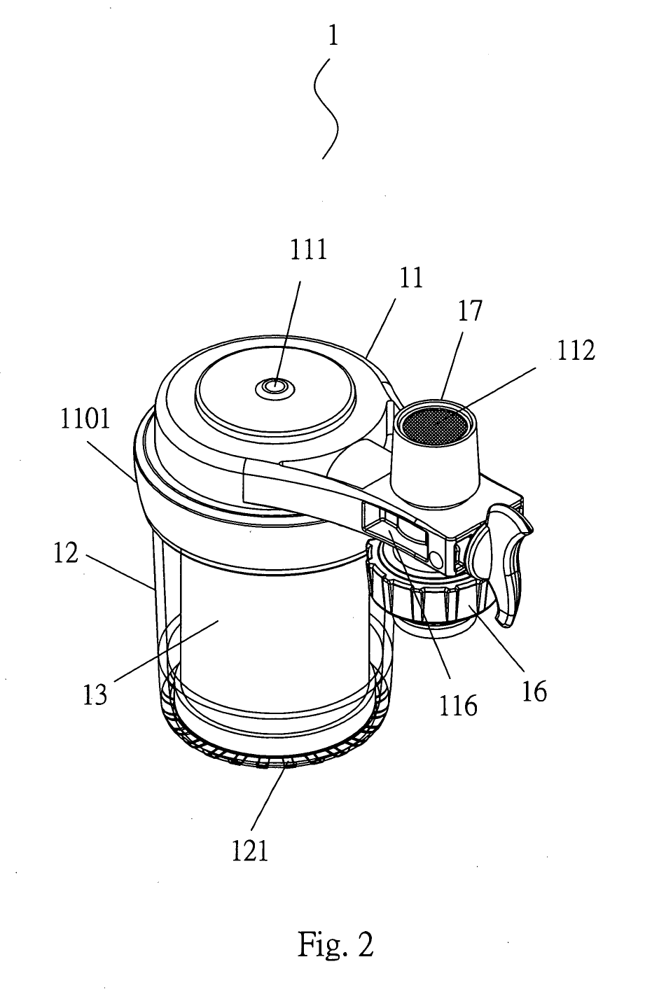

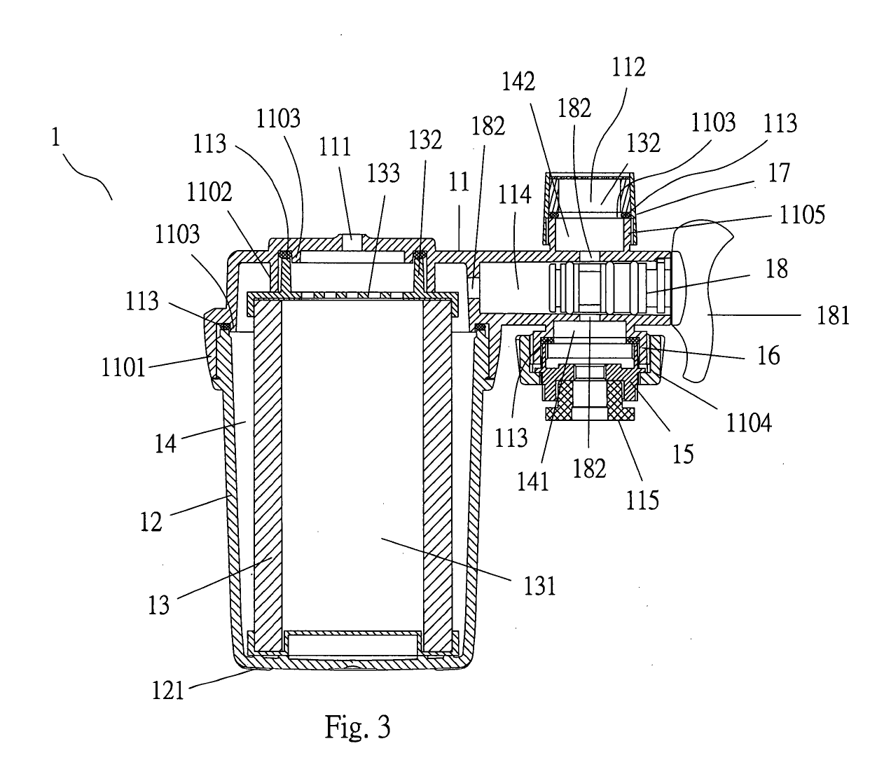

Referring to FIGS. 1, 2 and 3, the exploded schematic view of the multi-functional water-filtering device 1 of the present invention is illustrated.

The multi-functional water-filtering device 1 of the present invention has a seat 11, a cylinder body 12 combined at a lower side of the seat 11, and a filter body 13 within the seat 11 and the cylinder body 12. The cylinder body 12 is made of transparent material. A large groove 14 is formed between the filter body 13, the seat 11 and the cylinder body 12.

The seat 11 has a steam-line structure. An inner side of the seat 11 has a filter body 13. A lower end of the seat 11 is an outer ring 1101. An inner wall of the outer ring 1101 is formed with threads.

An inner ring 1102 and two small rings 1103 are formed within the large groove 14. A first recess is formed between the outer ring 1101 and one of the small ring 1103. A rubber ring 113 is formed in the recess for water proof. A second recess is formed between the other small ring 1103 and the inner ring 1102. Another rubber ring 113 is formed in the second recess for water proof. A top center of the large groove 14 is formed with a filter water outlet 111. The lower side of the cylinder body 12 has a plurality of ribs 121. An upper side of the cylinder body 12 has threads for locking to the outer ring 1101 and are tightly engaged with the rubber ring 113 so as to form a water proof structure.

An interior of the cylinder body 12 is installed with a filter body 13 for filtering the particles in the water so that only fine particle can pass through the filter body 13. The filter body 13 is made of high density ceramic material. A filter layer 133 is installed at a bottom side of the filter body 13. An interior of the filter body 13 is installed with a plurality of active carbon particles 131 for cleaning chemical material in the water to be filtered. An end surface of the filter body 13 is extended with a protruding ring 132 which can be embedded into the recess between the inner ring 1102 and the small ring 1103.

One lateral side of the seat 11 is formed with a lateral supporter 114. The lateral supporter is formed by two plates and a hollow space is formed between the two plates. One lateral side of the lateral supporter 14 is extended with a lower tube 141. An outer surface of the lower ring 110 has threads.

A lower side of the lower tube 141 is installed with a lower ring 1104. The lower ring 1104 is communicated to the lateral supporter 114 through a via hole 182. An inner wall of the lower tube 141 is protruded with a waterproof rubber ring 115. A lower end of the lower tube 141 is extended with a lower cover 16. A lower end of the lower cover 16 is installed with a metal joint 15. An outer cover 1104 encloses an outer periphery of the lower cover 16 and part of the periphery of the metal joint 15. An outer surface of the lower cover 16 is a coarse surface formed with a plurality of textures for assisting the operation of locking the outer cover 1104 so that the metal joint 15 and the rubber ring 115 are firmly secured within the lower cover 16 to be tightly engaged with the water tube of a faucet without permeation of water. An inner surface of the lower cover 16 is formed with threads. A water tube of a faucet can be received within the metal joint 15, the rubber ring 115 and the lower cover 16.

Furthermore, the metal joint is made of copper and is electroplated with a layer of nickel; and an outer surface of the metal joint 15 is formed with a textured coarse surface for receiving a coarse surface of an inner side of a spanner. Thereby a user can rotate a metal joint 15 to make the metal joint 15 enter into the faucet so as to reduce the installation time of the multi-functional water-filtering device 1. Moreover, the metal joint is a hollow joint and two outer ends of the metal joint are textured to be embedded into the lower cover firmly without movement.

An upper end of the lateral supporter 114 is extended with an upper tube 1105. The upper cover 1105 is communicated to the lateral supporter 114 through a via hole 182. An inner side of the upper tube 1105 is a small groove 142. An outer surface of the upper tube 1105 has threads. An upper cover 17 covers upon the upper tube 1105. An outer surface of the upper cover 17 is a textured coarse surface so as to assist the upper cover 17 to be engaged to the upper tube 1105. An inner surface of the upper cover 17 is formed with threads. An upper end of the upper tube 1105 is installed with a small ring 1103. A rubber ring 113 is placed between the upper tube 1105 and the small ring 1103. An inner side of the small ring 1103 is formed with a water outlet 112. A filter layer 132 is placed on the interface of the small ring 1103 and the upper tube 1105. The upper cover 17 is made of copper and is electroplated with a nickel layer. The upper cover 17 has a larger opening at one end and has a smaller opening at another end; the two openings are flushed. An interior of the upper cover has a protruding ring; and a recess is formed between an inner wall of the upper cover and the small ring and a rubber ring is installed in the recess.

A valve body 18 is at an end surface of the lateral supporter 114 far away from the seat 1 1 and one end of the valve body 18 is installed with a handle 181. By rotating the handle 181, the valve body 18 is switched to receive different kinds of waters. Two lateral sides of the lateral supporter 114 are formed with respective recesses 116 between the upper cover 17 and the lower cover 16 for providing preferred force applying points as screwing or releasing the upper cover 17 and the lower cover 16.

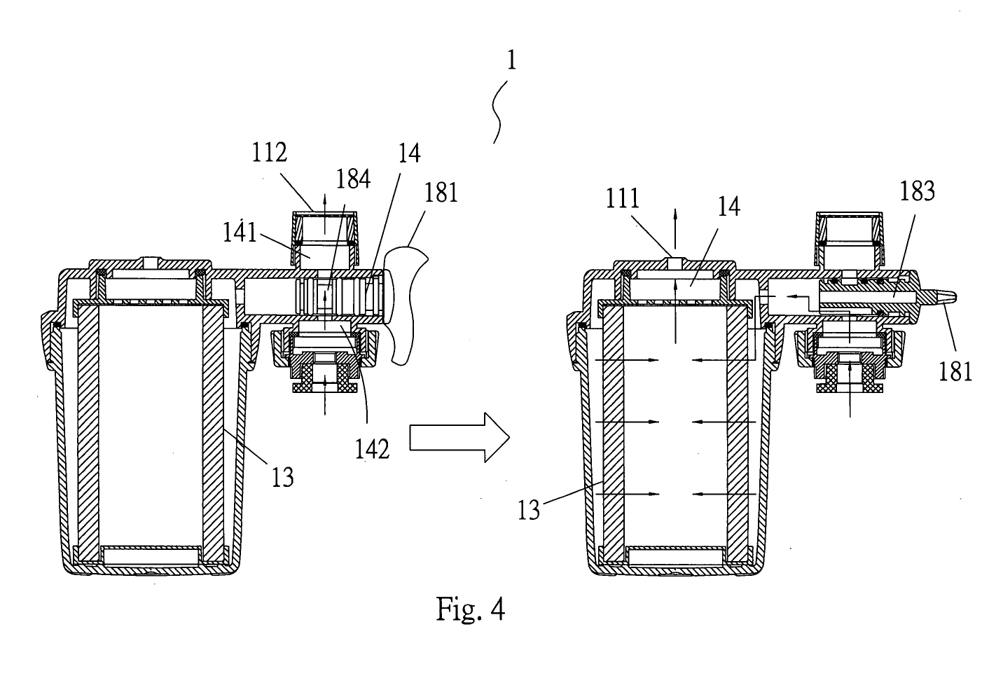

Referring to FIG. 4, the switching operation of the multi-functional water-filtering device of the present invention is illustrated. When the handle 181 of the multi-functional water-filtering device 1 is switched to a upright position, a cambered trench 184 of the valve body 18 is communicated to a lower tube 141 and the small groove 142 so as to drain the water from the outlet 112. When the handle 181 is switched to a horizontal position, a trench 183 at the lateral side is communicated to the lateral supporter 14 so as to guide water into the filter body 13 in the lateral supporter 14. The filtered water is drained out from the outlet 111.

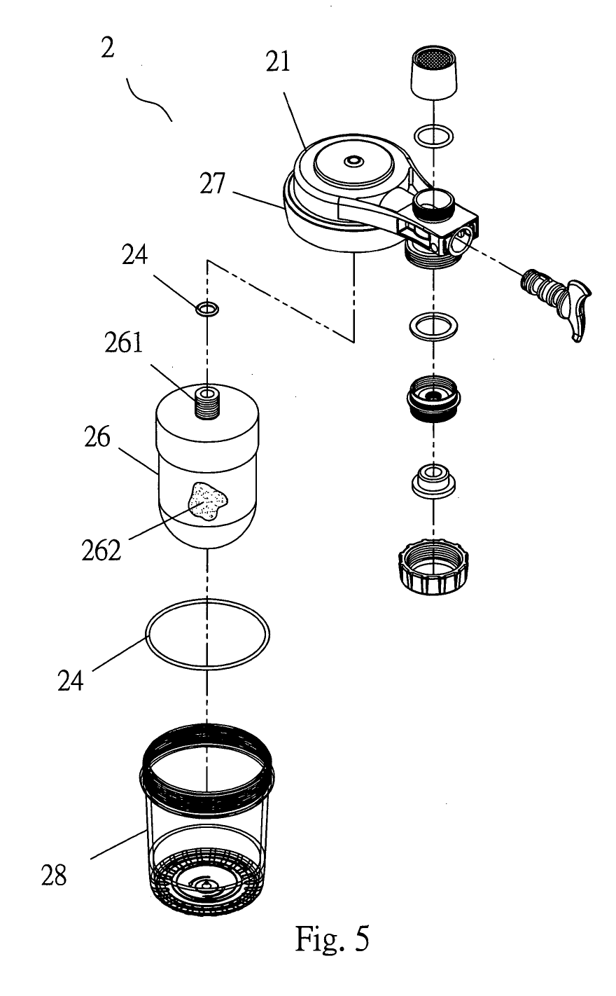

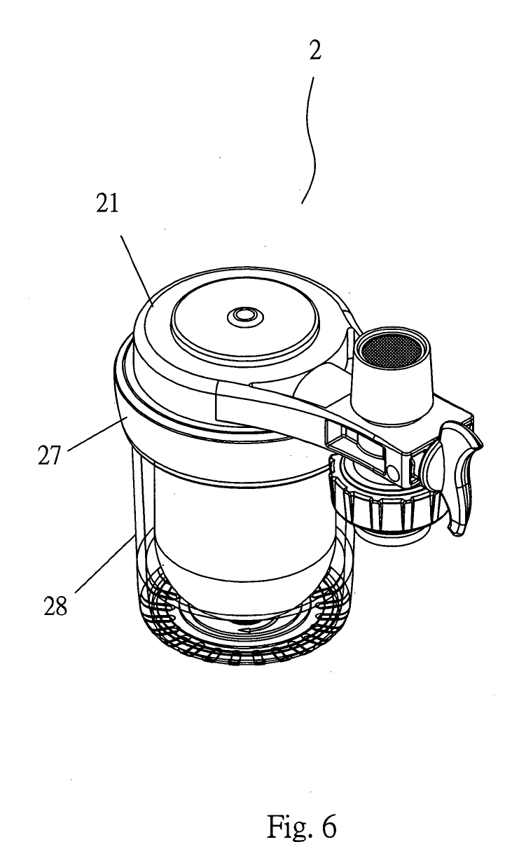

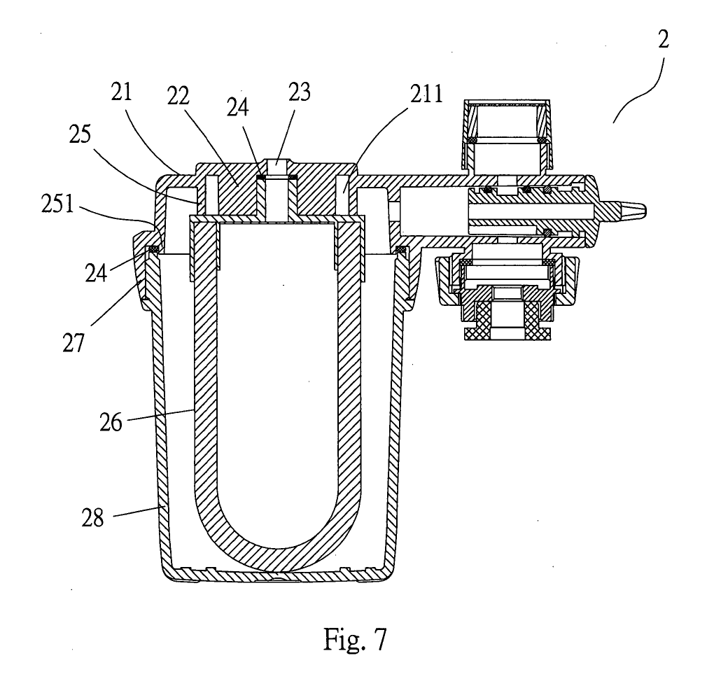

Referring to FIGS. 5, 6 and 7, another embodiment of the multi-functional water-filtering device of the present invention is illustrated. An inner side of the seat 11 is formed with a first ring 22, a second ring 25, and a third ring 251 which are located from the center toward the outer side of the interior of the seat 11. A top center of the seat 11 is installed with a through hole 23 as water outlet of filleted water. One end of the through hole 23 is threaded and the other end of the through hole 23 is formed with a smooth wall. An interior of the through hole 23 is installed with a waterproof rubber ring 24. A lower side of the through hole 23 is installed with a filter body 26. An interior of the filter body 26 is filled with active carbon particles 262. One end surface of the filter body 26 is extended with a hollow post 261. An outer surface of the hollow post 21 is threaded for locking the hollow post 261 to the through hole 23 and tightly engaged to the rubber ring 24 for prevent the permeation of water. Thereby the filter body 26 is combined to the seat 21. A recess 211 is formed between the first ring 22 and the second ring 25 for engaging the filter body 26. A lower side of the seat 21 is extended with a lower ring 27. An annular recess is formed between the lower ring 27 and the third ring 251 for receiving a waterproof rubber ring 24. An inner side of the lower ring 27 is threaded for locking the cylinder body 28 to the lower ring 27 and the rubber ring 24 is tightly engaged to prevent the permeation of water. Thereby the different specification of seat can be used in the present invention.

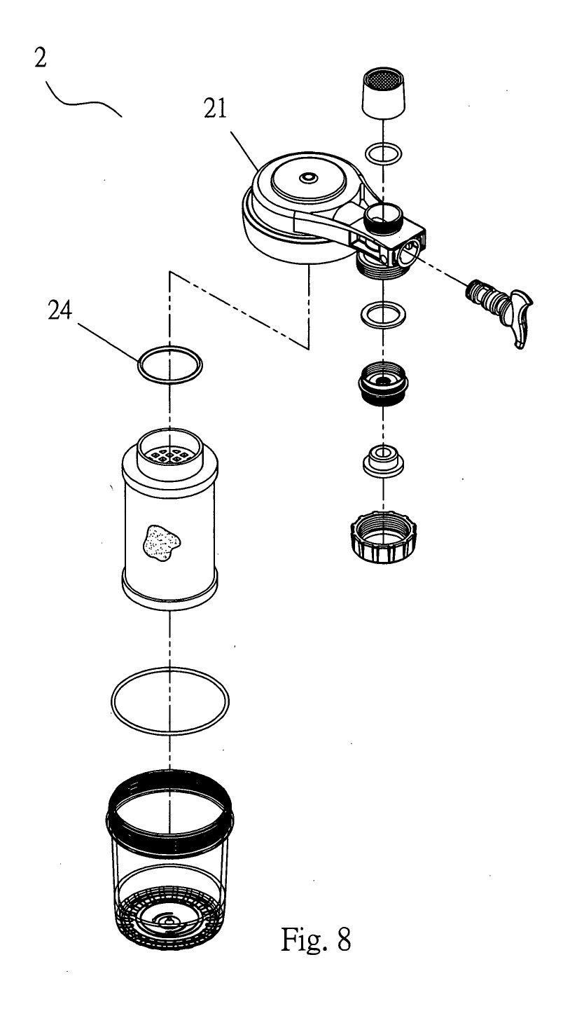

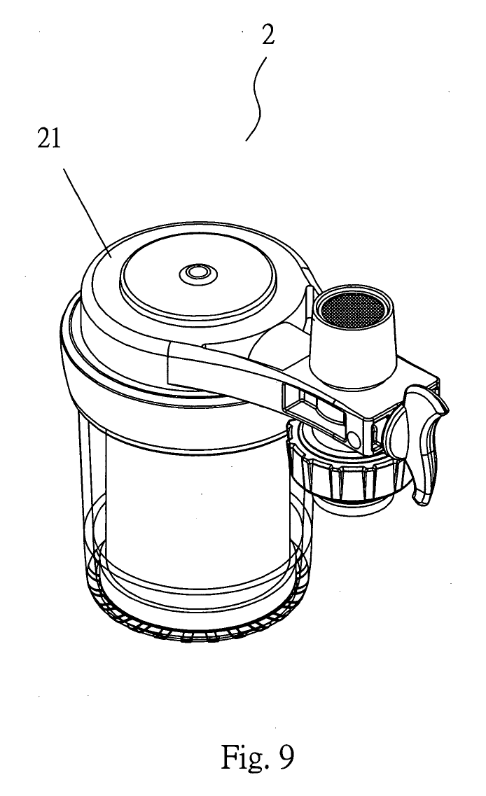

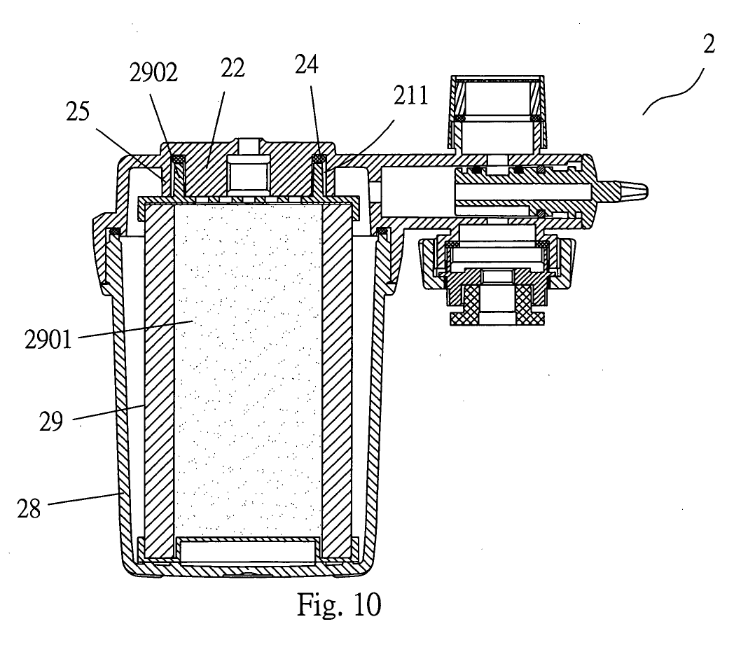

Referring to FIGS. 8, 9 and 10, another embodiment of the present invention is illustrated. It is illustrated that a recess 211 is installed between the first ring 22 and the third ring 25 for receiving a waterproof rubber ring 24. A lower end of the first ring 22 is installed with a filter body 29 with active carbon particles 2901 therein. One end of the filter body 29 is extended with an annular post 2902 which can be embedded into the recess 211 so as to lock the cylinder body 28 to the seat 21.

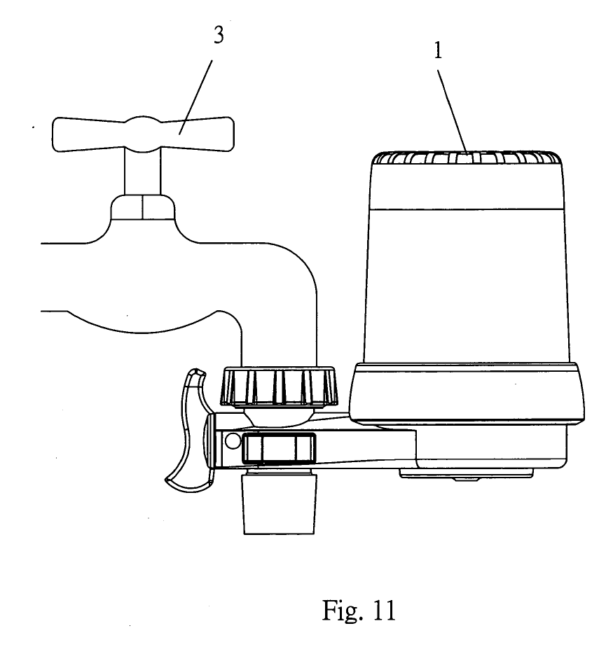

Referring to FIG. 11, one application of the multi-functional water-filtering device 1 of the present invention is illustrated. An outer side of a water tube is connected with a rubber ring 115, a metal joint 15 and a lower cover 16. When the lower cover 16 is engaged to the lower ring 1104. The metal joint 15 within the lower cover 16 will tightly press the rubber ring 115 to prevent the permeation of water so that the multi-functional water-filtering device 1 is tightly engaged to the faucet 3. If too much impurities are remained in the filter body 13 so that the color of filter body 13 is changed, it can be seen from the transparent cylinder body 12.

Advantages of the present invention is that the multi-functional water-filtering device is locked to the faucet with less space. No water tube is used so that the pollution is reduced and it is difficult to the growth of germs. The impurities of the filter body can be seen by eyes. The filter layer will refine the particle in the water so as to be absorbed by human bodies easily and effectively. Furthermore, different kinds of filter bodies can be updated in the present invention. Two sides of the lateral supporter are formed with recesses so that the upper cover and lower cover can be locked easily.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-functional water-filtering device comprising:
a seat, a cylinder body combined at a lower side of the seat, and a filter body within the seat and the cylinder body; a large groove being formed between the filter body, the seat and the cylinder body;
an inner side of the seat having the filter body; a lower end of the seat being connected to an outer ring;
an inner ring and two small rings being formed within the large groove; the two small rings being located at two opposite sides of the inner ring; a first recess being formed between the outer ring and one of the small ring; a rubber ring being formed in the recess for water proof; a second recess being formed between the other small ring and the inner ring; another rubber ring being formed in the second recess for water proof;
an interior of the cylinder body being installed with a filter body for filtering the particles in the water; an end surface of the filter body being extended with a protruding ring which is embedded into the recess between the inner ring and the small ring;
one lateral side of the seat being formed with a lateral supporter; the lateral supporter being formed by two plates and a hollow space being formed between the two plates; one lateral side of the lateral supporter being extended with a lower tube;
a lower side of the lower tube being installed with a lower ring; the lower ring being communicated to the lateral supporter through a first via hole; an inner wall of the lower tube being protruded with a waterproof rubber ring; a lower end of the lower tube being extended with a lower cover; a lower end of the lower cover being installed with a metal joint; an outer cover enclosing an outer periphery of the lower cover and part of the periphery of the metal joint; and
an upper end of the lateral supporter being extended with an upper tube; the upper cover being communicated to the lateral supporter through a via hole; an inner side of the upper tube being a small groove; and an upper cover covering upon the upper tube;

2. The multi-functional water-filtering device as claimed in claim 1, wherein a lower side of the cylinder body has a plurality of ribs; an upper side of the cylinder body has threads for locking to the outer ring and are tightly engaged with the rubber ring so as to form a water proof structure.

3. The multi-functional water-filtering device as claimed in claim 1, wherein a top center of the large groove is formed with a filter water outlet.

4. The multi-functional water-filtering device as claimed in claim 1, wherein the filter body is made of high density ceramic material; and the filter layer is installed at a bottom side of the filter body.

5. The multi-functional water-filtering device as claimed in claim 1, wherein the seat is a plate with stream-line shape.

6. The multi-functional water-filtering device as claimed in claim 1, wherein a valve body is at one end of the lateral supporter far away from the seat and one end of the valve body is installed with a handle; by rotating the handle, and the valve body is switched to receive different kinds of waters.

7. The multi-functional water-filtering device as claimed in claim 1, wherein the metal joint is a hollow joint and two outer ends of the metal joint are textured so as to be embedded into the lower cover firmly without movement.

8. The multi-functional water-filtering device as claimed in claim 1, wherein the metal joint is made of copper and is electroplated with a layer of nickel; an outer surface of the metal joint is formed with a textured coarse surface for receiving a coarse surface of an inner side of a spanner; when the metal joint is rotated, the metal joint enters into the faucet so as to reduce the installation time of the multi-functional water-filtering device.

9. The multi-functional water-filtering device as claimed in claim 1, wherein the upper cover is made of copper and is electroplated with a nickel layer; the upper cover has a larger opening at one end and has a smaller opening at another end; the two openings are flushed; an interior of the upper cover has a protruding ring; and a recess is formed between an inner wall of the upper cover and the small ring and a rubber ring is installed in the recess.

10. The multi-functional water-filtering device as claimed in claim 1, wherein an upper end of the upper tube is installed with a small ring; a rubber ring is placed between the upper tube and the small ring; an inner side of the small ring is formed with a water outlet; and a filter layer is placed on the interface of the small ring and the upper tube.

11. The multi-functional water-filtering device as claimed in claim 1, wherein two lateral sides of the lateral supporter are formed with respective recesses between the upper cover and the lower cover for providing force applying points as screwing or releasing the upper cover and the lower cover.

12. The multi-functional water-filtering device as claimed in claim 1, wherein an outer surface of the lower cover is a coarse surface formed with a plurality of textures for assisting the operation of locking the outer cover so that the metal joint and the rubber ring are firmly secured within the lower cover to be tightly engaged with the water tube of a faucet without permeation of water; an inner surface of the lower cover is formed with threads; a water tube of a faucet can be received within the metal joint, the rubber ring and the lower cover.

13. The multi-functional water-filtering device as claimed in claim 1, wherein the cylinder body is made of transparent material.

14. The multi-functional water-filtering device as claimed in claim 1, wherein the filter body is installed with active carbon particles.
